(19) United States
(12) Patent Application Publication
(10) Pub. No.: US 2025/0007064 A1
(43) Pub. Date: Jan. 2, 2025

(54) EXPANSION SYSTEMS AND METHODS FOR BATTERY PACK

(71) Applicant: Electric Power Systems, Inc., North Logan, UT (US)

(72) Inventors: James Banwell, Montclair, CA (US); Randy Dunn, Orange, CA (US)

(73) Assignee: Electric Power Systems, Inc., North Logan, UT (US)

(21) Appl. No.: 18/885,296

(22) Filed: Sep. 13, 2024

Related U.S. Application Data
(63) Continuation-in-part of application No. PCT/US2023/015155, filed on Mar. 14, 2023.
(60) Provisional application No. 63/607,527, filed on Dec. 7, 2023.
(60) Provisional application No. 63/319,653, filed on Mar. 14, 2022.

(51) Int. Cl. H01M 50/242; H01M 10/04; H01M 50/211; H01M 50/289; H01M 50/533

(52) U.S. Cl. CPC H01M 50/242; H01M 10/0481; H01M 50/211; H01M 50/289; H01M 50/533

(57) ABSTRACT

A battery module can comprise: an end plate; a pressure plate spaced apart from the end plate by a distance; an array of pouch cells disposed between the end plate and the pressure plate; and an expansion protection system configured to allow the distance to increase from a first length to a second length in response to charging the array of pouch cells, and/or decrease from a second length to the first length or a third length in response to discharging the array of pouch cells.

### CROSS-REFERENCE TO RELATED APPLICATIONS

This application claims priority to U.S. Provisional Application Ser. No. No. 63/607,527, filed Dec. 7, 2023, titled “EXPANSION SYSTEMS AND METHODS FOR BATTERY PACK,” and is a continuation in part, claims priority to PCT/US2023/015155, filed Mar. 14, 2023, titled “EXPANSION SYSTEMS AND METHODS FOR BATTERY PACK.” The '155 Application, claims priority to, U.S. Provisional Application Ser. No. 63/319,653, filed Mar. 14, 2022, titled “EXPANSION SYSTEMS AND METHODS FOR BATTERY PACK.” Each application is hereby incorporated by reference in their entirety for all purposes.

### FIELD OF INVENTION

The present disclosure generally relates to apparatus, systems and methods for providing battery systems with expansion capability to facilitate alternative battery chemistries.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may be inventions.

A battery module, for purposes of this disclosure, includes a plurality of electrically connected electrochemical or electrostatic cells hereafter referred to collectively as “cells”. These cells may, in turn, include a parallel, series, or combination of both, collection of, cells that can be charged electrically to provide a static potential for power or released electrical charge when needed. When cells are assembled into a battery module, the cells are often linked together through metal strips, straps, wires, bus bars, etc., that are welded, soldered, or otherwise fastened to each cell to link them together in the desired configuration.

A cell may be comprised of at least one positive electrode and at least one negative electrode. One common form of such a cell is the well-known secondary cells packaged in a cylindrical metal can or in a prismatic case. Examples of chemistry used in such secondary cells are lithium cobalt oxide, lithium manganese, lithium iron phosphate, nickel cadmium, nickel zinc, and nickel metal hydride. Such cells are mass produced, driven by an ever-increasing consumer market that demands low-cost rechargeable energy for portable electronics.

### SUMMARY OF THE INVENTION

Disclosed herein is a battery module having an expansion protection system. The battery module includes a plurality of cells electrically coupled together (e.g., in series and/or in parallel). The battery module is configured to facilitate expansion and compression of each cell in the plurality of cells without a corresponding stress being generated on any of the plurality of cells. In this regard, the battery module disclosed herein, and associated expansion protection systems and methods, can result in significantly lighter battery modules that can produce a similar amount of energy relative to a typical battery module, in accordance with various embodiments. Alternatively, the battery module disclosed herein, and associated expansion protection systems and methods, can result in a greater energy output for a similar weight relative to a typical battery module, in accordance with various embodiments.

The expansion protection system allows a length of an array of pouch cells to increase from a first length to a second length in response to charging the array of pouch cells. In this regard, the array of pouch cells are given freedom in a longitudinal direction to expand, and the expansion protection system can comprise a biasing mechanism to return the array of pouch cells to a default position after charging, in accordance with various embodiments.

The battery module and expansion protection systems disclosed herein can facilitate use of alternative battery chemistries compared to typical battery chemistries that have otherwise been avoided due to their reaction during charging, in accordance with various embodiments.

### BRIEF DESCRIPTION OF THE DRAWINGS

A more complete understanding of the present disclosure may be derived by referring to the detailed description and claims when considered in connection with the Figures, wherein like reference numbers refer to similar elements throughout the Figures, and where:

FIG. 1 illustrates a schematic view of a battery module, in accordance with various embodiments;

FIG. 2A illustrates a perspective view of a battery module, in accordance with various embodiments;

FIG. 2B illustrates a perspective view of a battery module, in accordance with various embodiments;

FIG. 3 illustrates a detail view of a set of pouch cells in a battery module, in accordance with various embodiments;

FIG. 4A illustrates a top view of a battery module in a charged state, in accordance with various embodiments;

FIG. 4B illustrates a top view of a battery module during a fully discharged state, in accordance with various embodiments;

FIG. 4C illustrates a top view of a battery module in a discharged state after various cycles of use, in accordance with various embodiments;

FIG. 5A illustrates a perspective view of an expansion protection system for a battery module, in accordance with various embodiments;

FIG. 5B illustrates a perspective view of an expansion protection system for a battery module, in accordance with various embodiments;

FIG. 6A illustrates a top-down view of a battery system with an expansion protection system for a battery module, in accordance with various embodiments;

FIG. 6B illustrates a top-down view of a battery system with an expansion protection system for a battery module, in accordance with various embodiments;

FIG. 7 illustrates a method of assembling an expansion protection system for a battery system, in accordance with various embodiments.

### DETAILED DESCRIPTION

The following description is of various example embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments, without departing from the scope of the appended claims. For example, the steps recited in any of the method or process descriptions may be executed in any order and are not necessarily limited to the order presented. Moreover, many of the manufacturing functions or steps may be outsourced to or performed by one or more third parties. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. As used herein, the terms “coupled,” “coupling,” or any other variation thereof, are intended to cover a physical connection, an electrical connection, a magnetic connection, an optical connection, a communicative connection, a functional connection, and/or any other connection.

For the sake of brevity, conventional techniques for mechanical system construction, management, operation, measurement, optimization, and/or control, as well as conventional techniques for mechanical power transfer, modulation, control, and/or use, may not be described in detail herein. Furthermore, the connecting lines shown in various figures contained herein are intended to represent example functional relationships and/or physical couplings between various elements. It should be noted that many alternative or additional functional relationships or physical connections may be present in a modular structure.

As referred to herein, “abuts” means in contact with. Abuts can mean in loose contact with, coupled to (e.g., fixedly or moveably coupled to), or the like. The present disclosure is not limited in this regard.

Energy cells have been developed for a wide range of applications using a variety of different technologies, resulting in a wide range of available performance characteristics. The nominal voltage of a galvanic cell is fixed by the electrochemical characteristics of the active chemicals used in the cell, the so called cell chemistry. The actual voltage appearing at the terminals at any particular time, as with any cell, depends on the load current and the internal impedance of the cell and this varies with, temperature, the state of charge and with the age of the cell.

There are various characteristics used to define a battery cell's performance capabilities. For example, performance characteristics for a given battery cell can include discharge curves, discharge rates, duty cycle, cycle life, etc. Performance characteristics can change based on various cell or operating parameters. For example, performance characteristics can further depend on cell chemistry, operating conditions (e.g., operating temperature, discharge rate, etc.), or the like. Of growing importance, as battery cells are being utilized in aeronautical applications to a significantly larger degree is energy density for a battery cell (or a battery module as a whole). “Energy density” as referred to herein defines battery capacity in weight (Wh/kg). Stated another way, energy density for a battery cell (or a battery module) defines a discharge current the battery cell (or battery module) can deliver over time per unit of weight. As weight is a significant factor in aeronautical applications, energy density for battery modules is becoming increasingly important.

Currently, lithium-ion batteries are the most common energy sources for cells that form battery modules and are known for having relatively high energy density. Alternative battery chemistries, such as lithium-silicon cells, have even greater energy density relative to lithium-ion cells; however, due to certain drawbacks, applications of these alternative battery chemistries have not been readily explored. In particular, lithium-silicon cells are prone to significant physical expansion of the material during charging of the cell. For example, during charging of a lithium-silicon cell, a volume of the cell may increase by approximately 320% its original volume. This expansion, and then contraction in discharge, can cause stress cracks to form in the material, increasing impedance and reducing capacity. For example, typical lithium-silicon based battery modules lose most of their capacity in as few as 10 charge-discharge cycles. Although described herein with respect to lithium-silicon based cells, the present disclosure is not limited in this regard, and any cell chemistry that results in expansion during charging is within the scope of this disclosure. For example, lithium-aluminum cells, lithium-tin cells, metallic lithium cells, or any other cell chemistry known for expansion during charging is within the scope of this disclosure.

Disclosed herein is a battery module having an expansion protection system. The battery module includes a plurality of cells electrically coupled together (e.g., in series and/or in parallel). The battery module is configured to facilitate expansion and compression of each cell in the plurality of cells. In this regard, the battery module disclosed herein, and associated expansion protection systems and methods, can result in significantly lighter battery modules that can produce a similar amount of energy relative to a typical battery module, in accordance with various embodiments. Alternatively, the battery module disclosed herein, and associated expansion protection systems and methods, can result in a greater energy output for a similar weight relative to a typical battery module, in accordance with various embodiments.

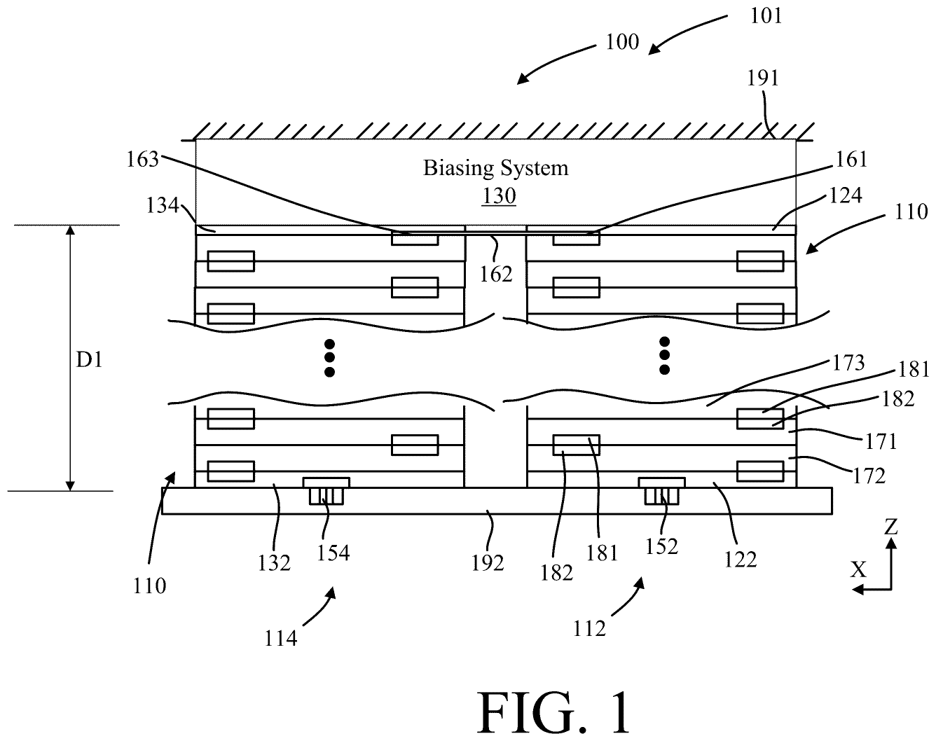

Referring now to FIG. 1 a schematic top view of a battery module 100 is illustrated, in accordance with various embodiments. The battery module 100 includes an expansion protection system 101 and an array of pouch cells 110. In various embodiments, the expansion protection system 101 is configured to maintain a pressure supplied to the array of pouch cells 110 as each pouch cell in the array of pouch cells 110 expand and contract as described further herein. In various embodiments, each pouch cell in the array of pouch cells 110 is a lithium-silicon based cell. Although described herein as lithium-silicon based cells, the present disclosure is not limited in this regard. For example, other cell chemistries, that swell, such as lithium-aluminum based cells are within the scope of this disclosure.

In various embodiments, each pouch cell in the array of pouch cells 110 is one of a lithium-silicon based cell or a lithium-metal based cell. In this regard, each pouch cell in the array of pouch cells 110 can include a higher energy density relative to typical cells and be configured to expand significantly more during charging relative to typical cells, in accordance with various embodiments.

In various embodiments, the expansion protection system 101 is a passive system. For example, the expansion protection system 101 can passively facilitate expansion and contraction of an array of cells during charging (or operation) of the battery module 100, in accordance with various embodiments. Although described herein as including an expansion protection system 101 that is passive, the present disclosure is not limited in this regard. For example, an expansion protection system 101 can be an active expansion protection system (i.e., where a pressure being applied to the battery module 100 is continuously monitored and/or adjusted) and is still within the scope of this disclosure. In various embodiments, by having a passive system for the expansion protection system 101, a weight and part count of the battery module 100 can be greatly reduced relative to an active system, which provides additional benefits for aeronautical type applications.

In various embodiments, the array of pouch cells 110 include a first row of pouch cells 112 and a second row of pouch cells 114. Although illustrated as including two rows of pouch cells (e.g., rows of pouch cells 112, 114), the present disclosure is not limited in this regard. For example, any number of rows of pouch cells is within the scope of this disclosure, such as a single row of pouch cells (e.g., the first row of pouch cells 112 only) to greater than 10 rows of pouch cells (i.e., spaced apart laterally in the X-direction), in accordance with various embodiments. In various embodiments, by having an even number of rows of pouch cells, a positive terminal 152 and a negative terminal 154 for the array of pouch cells 110 can be disposed on the same side of the battery module (i.e., a fixed side). In this regard, a terminal of the array of pouch cells 110 will not have to be configured to translate during charging or discharging of the array of pouch cells 110 as described further herein.

In various embodiments, the battery module 100 further comprises a support structure 191 spaced apart longitudinally (i.e., in a Z-direction) from a support structure 192. The array of pouch cells 110 are configured to be disposed between the support structures 191, 192. The expansion protection system 101 includes a biasing system 130. The biasing system 130 is disposed between the support structure 191 and the array of pouch cells 110. In various embodiments, the biasing system 130 is coupled to the support structure 191. However, the present disclosure is not limited in this regard. For example, the biasing system 130 can be configured to abut the support structure 191 without a hard connection, as described further herein, and still be within the scope of this disclosure.

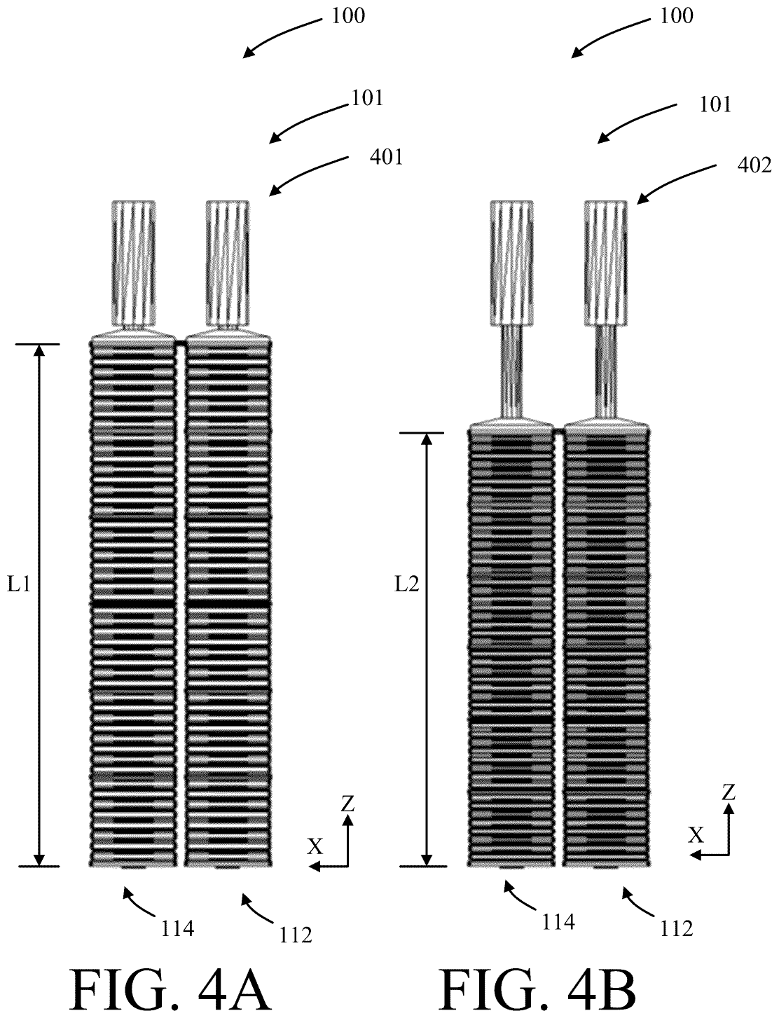

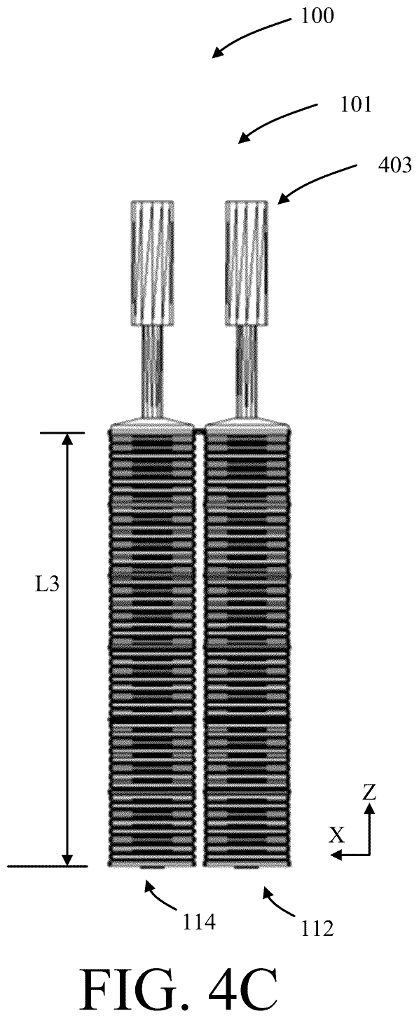

The biasing system 130 may be spaced apart from the support structure 192 by a distance D1. The expansion protection system 101 is configured to allow the distance D1 to increase from a first length (e.g., length L2 from FIG. 4B) to a second length (e.g., length L1 from FIG. 4A) in response to transitioning the battery module 100 from a discharged state (FIG. 4B) to a charged state (FIG. 4A), as described further herein.

In various embodiments, each pouch cell in a row of pouch cells 112, 114 abuts an adjacent pouch cell in the row of pouch cells 112, 114. In various embodiments, a majority of pouch cells in each row of pouch cells 112, 114 abuts two adjacent pouch cells in the row of pouch cells 112, 114. For example, a first pouch cell 171 in the array of pouch cells 110 abuts a second pouch cell 172 on a first side (i.e., a first longitudinal side) and a third pouch cell 173 on a second side (i.e., a second longitudinal side). Each pouch cell in the array of pouch cells 110 comprises a positive tab spaced apart laterally (i.e., in an X-direction) from a negative tab. For example, the first pouch cell 171 comprises a positive tab 181 spaced apart laterally from a negative tab 182. In various embodiments, the positive tab 181 of the first pouch cell 171 is physically and electrically coupled to the negative tab 182 of the second pouch cell 172 on a first lateral side of the first pouch cell 171. Similarly, the negative tab 182 of the first pouch cell 171 is physically and electrically coupled to the positive tab of the third pouch cell on a second lateral side of the first pouch cell. In this regard, the row of pouch cells 112, 114 can form an electrical path in series from pouch cell to pouch cell, in accordance with various embodiments. In various embodiments, by coupling the pouch cells in the array of pouch cells 110 as described herein, each row of pouch cells 112, 114 can expand and contract in a similar manner to an accordion. Accordingly, a stress experienced by each pouch cell in the array of pouch cells 110 can be greatly reduced relative to a system with a current collector, or other typical bus bars, which fix the pouch cells relative to the bus bars, in accordance with various embodiments.

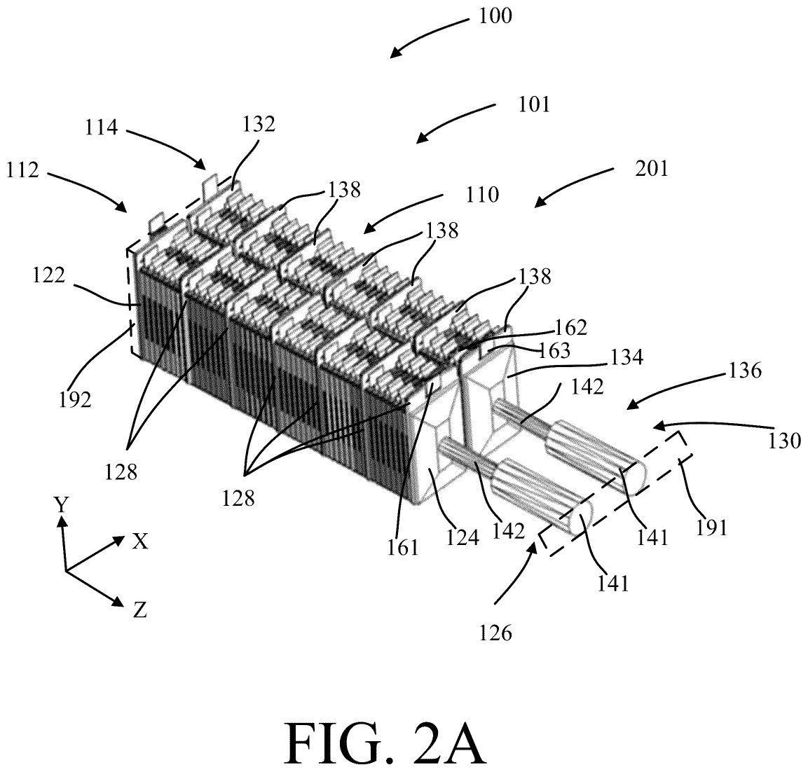

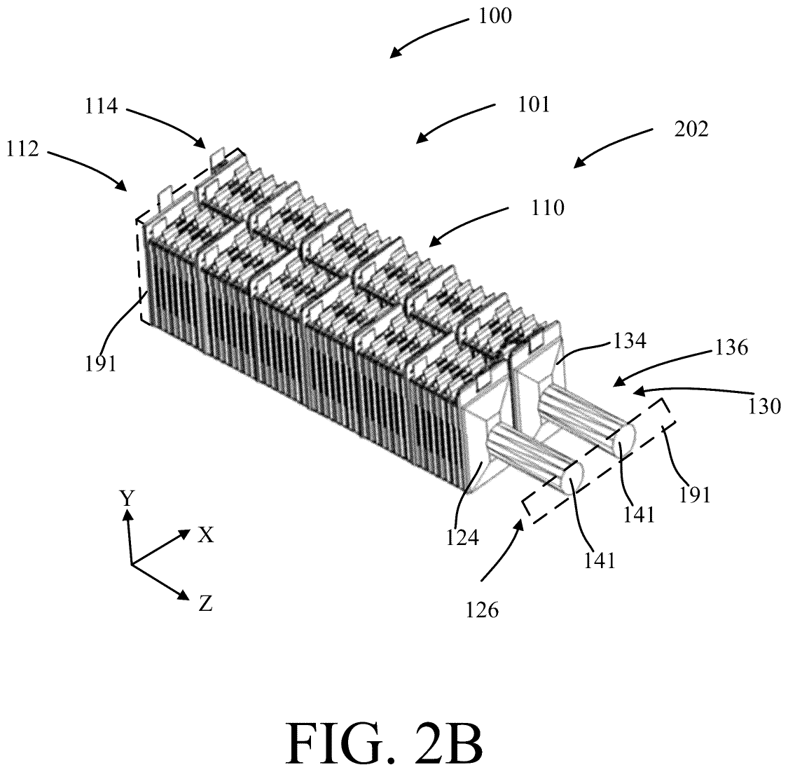

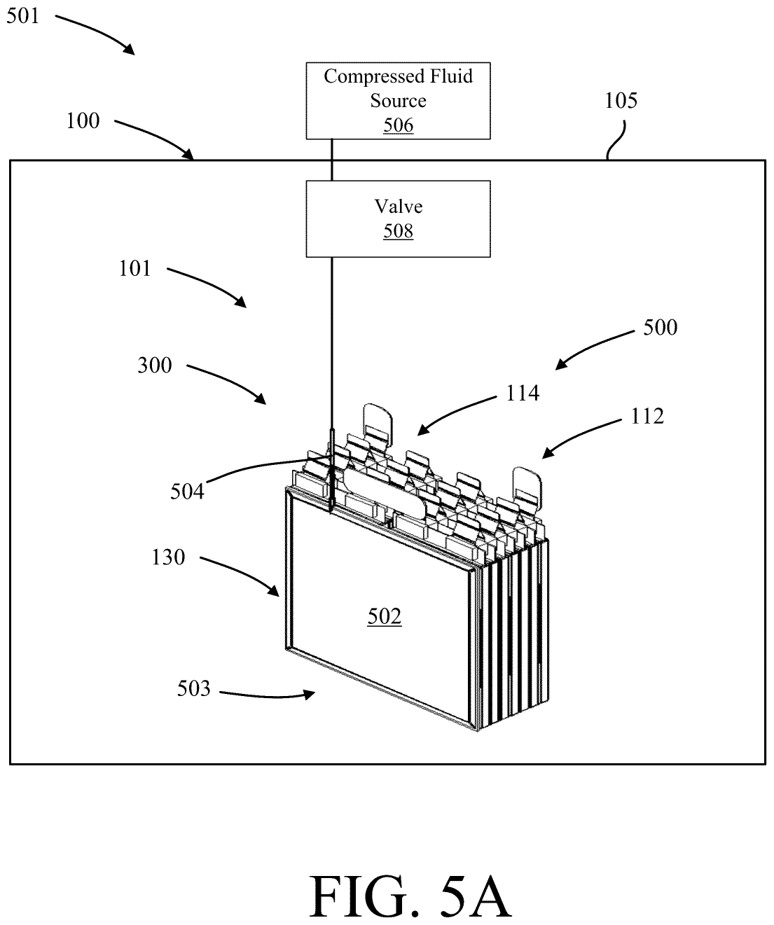

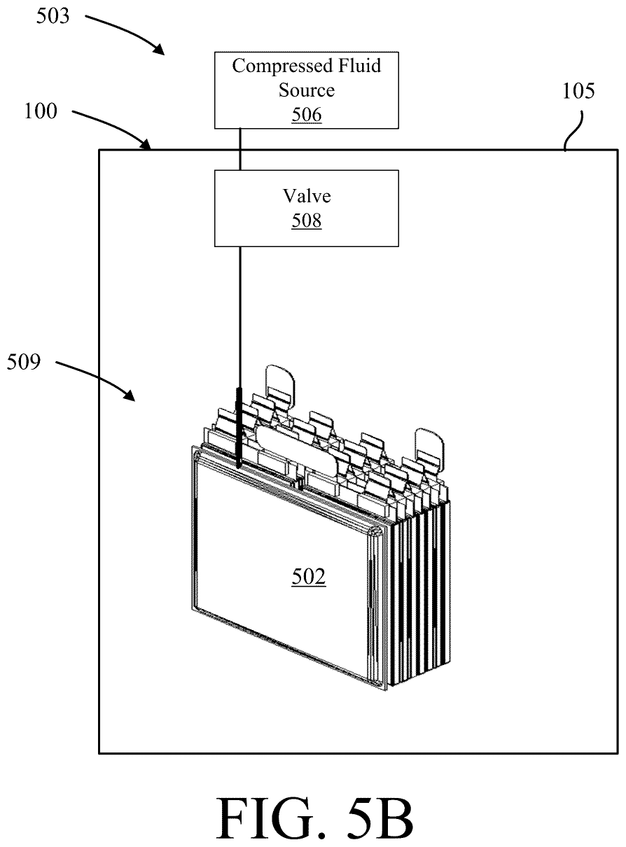

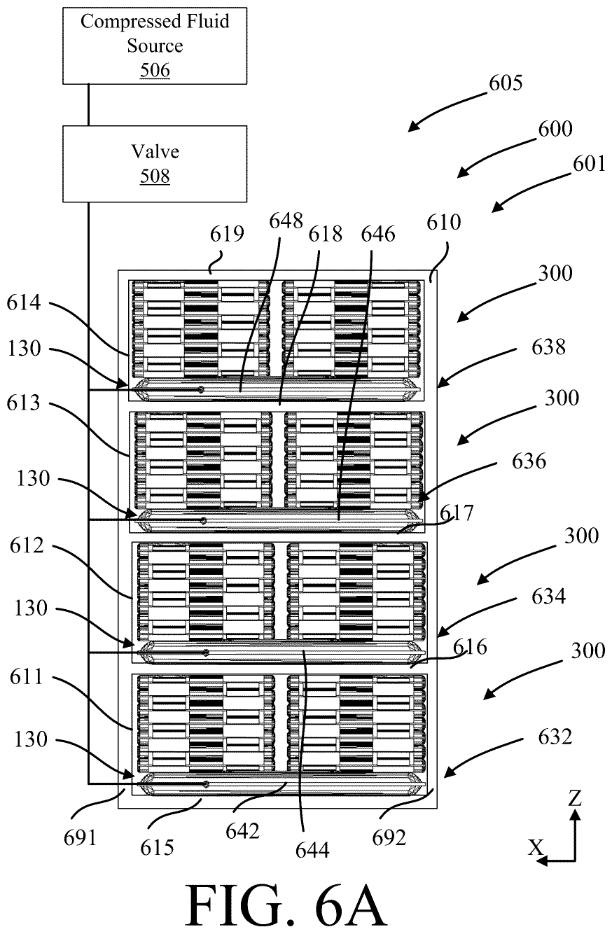

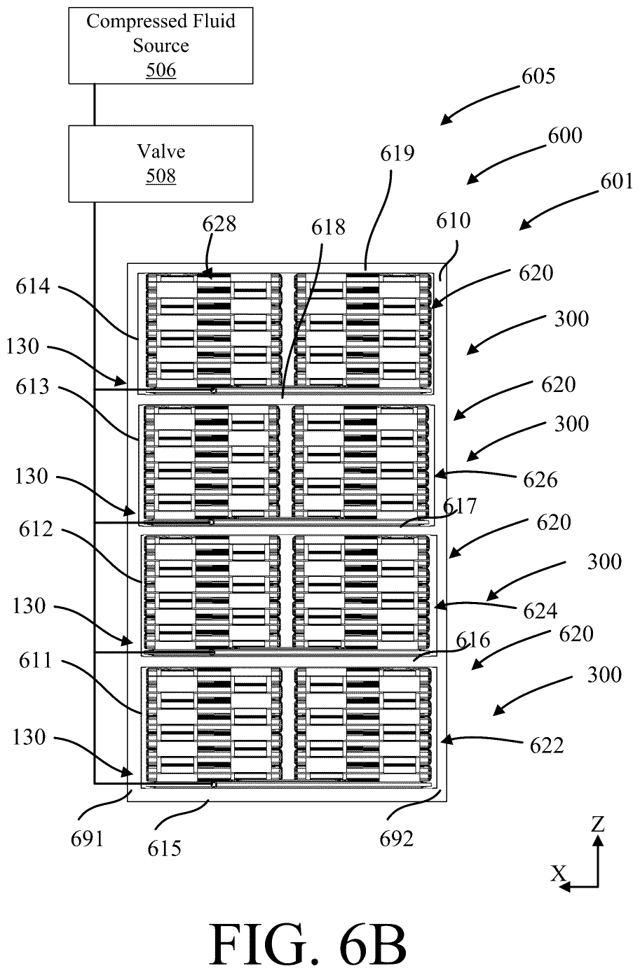

In various embodiments, as described further herein, the biasing system 130 comprises at least one biasing mechanism. In various embodiments, the biasing mechanism is configured to abut the support structure 191 and/or be coupled to the support structure 191. The present disclosure is not limited in this regard. For example, the biasing system 130 can comprise a bladder (e.g., bladder 502 as shown in FIGS. 5A, 5B), a plurality of the bladder (e.g., the plurality of the bladder 502 as shown in FIGS. 6A, 6B), a spring (e.g., biasing mechanism 126 or 136 as shown in FIGS. 2A, 2B), or the like. In various embodiments, the biasing system 130 can include a combination of bladder(s) and/or springs. The present disclosure is not limited in this regard.

In various embodiments, the first row of pouch cells 112 are disposed longitudinally (i.e., in the Z-direction) between end plate 122 and a pressure plate 124. Similarly, the second row of pouch cells 114 are disposed longitudinally (e.g., in the Z-direction) between end plate 132 and pressure plate 134. Stated another way, the first row of pouch cells 112 are spaced apart laterally (i.e., in the X-direction) from the second row of pouch cells 114. Although the end plates 122, 132 are illustrated as separate, distinct components, the present disclosure is not limited in this regard. For example, a single end plate can extend laterally (e.g., in the X-direction) across multiple arrays of pouch cells (e.g., from the first row of pouch cells 112 to the second row of pouch cells 114) and still be within the scope of this disclosure. In various embodiments, the end plates 122, 132, can be eliminated, and the array of pouch cells 110 can be coupled to the support structure 192 directly. The present disclosure is not limited in this regard.

Similarly, although the pressure plates 124, 134 are illustrated as separate, distinct components, the present disclosure is not limited in this regard. For example, a single pressure plate can extend laterally (e.g., in the X-direction) across multiple arrays of pouch cells (e.g., from the first row of pouch cells 112 to the second row of pouch cells 114) and still be within the scope of this disclosure. In various embodiments, by having separate pressure plates 124, 134, a difference in expansion between adjacent arrays can be controlled, resulting in reduced stresses compared to having a single pressure plate.

In various embodiments, adjacent pouch cells in a row of pouch cells 112, 114 can abut (i.e., be in contact with) each other or be spaced apart from each other, or the like. The present disclosure is not limited in this regard. As described further herein, during charging of the battery module 100, the pouch cells in the row of pouch cells 112, 114 expand, which results in adjacent pouch cells in the row of pouch cells 112, 114 applying pressure to each other and causing the row of pouch cells 112, 114 to grow in total length.

In various embodiments, a biasing system 130 is operably coupled to the pressure plate 124 and the pressure plate 134. As described further herein, the biasing system 130 can comprise a single biasing mechanism between the pressure plates 124, 134 and a support structure 191, a first biasing mechanism coupled to the pressure plate 124 and a second biasing mechanism coupled to the pressure plate 134, or a plurality of biasing mechanisms spaced apart longitudinally in the row of pouch cells 112, 114. The present disclosure is not limited in this regard, and as described further herein there can be various advantages to various configurations.

In various embodiments, the battery module 100 comprises a positive terminal 152 and a negative terminal 154. In various embodiments, the positive terminal 152 and the negative terminal 154 of the battery module 100 can be on the same longitudinal side of the battery module 100 (i.e., opposite, or distal to, the support structure 191 and the biasing system 130). In this regard, the positive terminal 152 and the negative terminal 154 can be disposed in a location with little to no displacement (e.g., a fixed location) to facilitate electrical coupling to a respective electrical load and/or to prevent damage to the electrical connection. In various embodiments, the array of pouch cells 110 define an electrical path from the positive terminal 152 to the negative terminal. In this regard, the electrical path can extend from the positive terminal 152, then from pouch cell to pouch cell in the first row of pouch cells 112 from the first longitudinal end of the battery module 100 (i.e., proximal the support structure 192) to the second longitudinal end of the battery module 100, then from pouch cell to pouch cell in the second row of pouch cells 114 from the second longitudinal end of the battery module 100 to the first longitudinal end of the battery module 100, then to the negative terminal 154, in accordance with various embodiments.

In various embodiments, the end plate 122 can comprise a pouch cell in the row of pouch cells 112 that defines the positive terminal 152. However, the present disclosure is not limited in this regard. For example, the end plate 122 can include a conductive element or the like electrically coupling a pouch cell in the row of pouch cells 112 to the positive terminal 152, in accordance with various embodiments. Similarly, the end plate 132 can comprise a pouch cell in the row of pouch cells 114 that defines the negative terminal 154. However, the present disclosure is not limited in this regard. For example, the end plate 132 can include a conductive element or the like electrically coupling a pouch cell in the row of pouch cells 114 to the negative terminal 154, in accordance with various embodiments. In various embodiments, the end plate 122 is disposed laterally adjacent to the end plate 132. “Laterally adjacent”, as referred to herein corresponds to being spaced apart in a lateral direction at a same longitudinal location of the battery module relative to the support structure 192, in accordance with various embodiments.

In various embodiments, the support structure 192 includes ports configured to receive the positive terminal 152 and the negative terminal 154. In various embodiments, the support structure 192 can transport the power generated from the battery module 100 to an external load or the support structure 192 can be a part of an electrical component powered by the battery module 100. The present disclosure is not limited in this regard.

In various embodiments, each cell in the row of pouch cells 112, 114 are electrically coupled together in series between the positive terminal 152 and the negative terminal 154 of the battery module. In this regard, an electrical path of the battery module 100 can define an accordion shape from a first longitudinal end of the row of pouch cells 112, 114 to a second longitudinal end of the row of pouch cells 112, 114. In various embodiments, the first row of pouch cells 112 is electrically coupled to the second row of pouch cells 114 at the longitudinal end proximal the biasing mechanisms 126, 136. In this regard, a conductive element 162 extends laterally (i.e., in the X-direction) from a tab 161 at a longitudinal end of the first row of pouch cells 112 to a tab 163 at a longitudinal end of the second row of pouch cells 114.

Referring now to FIGS. 2A and 2B, a perspective view of a battery module 100 with an expansion protection system 101 in fully discharged (or discharged) state 201 (FIG. 2A) and a fully charged (or charged) state 202 (FIG. 2B) are illustrated, with like numerals depicting like elements, in accordance with various embodiments. In various embodiments, a “discharged configuration” as referred to herein, is a newly manufactured state (i.e., a state where the battery module 100 has not undergone any charging or discharging cycles). In various embodiments, a “charged state” as referred to herein is a state of the battery module 100 after a charge. In various embodiments, after numerous charge and discharge cycles (i.e., various battery life cycles), a length of the row of pouch cells 112, 114 in the charged state 202 can increase relative to an initial charge state (i.e., after the battery module 100 is manufactured). In this regard, after each battery life cycle, the pouch cells in the array of pouch cells 110 can expand further than a prior state. In response to the expansion, the biasing system 130 can maintain a consistent pressure on the array of pouch cells 110 as described further herein. Accordingly, the expansion protection system 101 can extend a life of the array of pouch cells 110 by preventing damage to cells in the array of pouch cells in response to the expansion of the pouch cells, in accordance with various embodiments.

With reference now to FIG. 2A, in various embodiments, the battery module 100 can further comprise spacing plates, or separators (e.g., spacing plates 128, 138). For example, each array of pouch cells 110 (e.g., the first row of pouch cells 112 and the second row of pouch cells 114) can comprise spacing plates 128, 138 spaced apart in the longitudinal direction (i.e., the Z-direction) of the battery module 100. In various embodiments, the spacing plates 128, 138 are conductive. In this regard, a tab of one pouch cell on a first side of the spacing plate 128, 138 and a tab of one pouch cell on a second side of the spacing plate 128, 138 can each be coupled to the spacing plate 128, 138 to continue an electrical path. However, the present disclosure is not limited in this regard. For example, the spacing plates 128, 138 can include an aperture for a bus bar, or the like to extend through connecting one tab on one side of the spacing plate 128 to another tab on a second side of the spacing plate 128, 138.

In various embodiments, the spacing plates 128, 138 can provide additional rigidity to the expansion protection system 101. In various embodiments, the spacing plates 128, 138 can separate the row of pouch cells 112, 114 into smaller packs of cells (e.g., sets of pouch cells). In this regard, an array of 50 pouch cells can be separated into 5 sets of 10 pouch cells with a spacing plate 128, 138 separating each set of pouch cells, in accordance with various embodiments. In various embodiments, any suitable number of pouch cells and sets of pouch cells may be used. Thus, the expansion and compression of the expansion protection system 101 can be robustly controlled and more uniform relative to a system without the spacing plates 128, 138. In various embodiments, the spacing plates 128, 138 act as a way to separate sets of pouch cells in a row of pouch cells 112, 114 and/or to allow a flat surface for electrical connections made when the set of pouch cells in the row of pouch cells 112, 114 are pressed together during expansion, as described further herein. Although illustrated as including spacing plates 128, 138, the present disclosure is not limited in this regard, and one skilled in the art may recognize various configurations without the use of spacing plates 128 and still be within the scope of this disclosure. For example, as described further herein, the spacing plates 128 can be replaced with biasing mechanisms of the biasing system 130, in accordance with various embodiments, and as described further herein.

With continued reference to FIGS. 2A and 2B, in various embodiments, the biasing system 130 comprises biasing mechanism 126 and biasing mechanism 136. For example, the pressure plate 124 can be spaced apart from the support structure 191. Similarly, the pressure plate 134 can be spaced apart from the support structure 191. The biasing mechanism 126 can be coupled to the pressure plate 124, and the biasing mechanism 136 can be coupled to the pressure plate 134. In this regard, the biasing mechanism 126 can be configured to supply a passive pressure to the pressure plate 124 independently of a passive pressure supplied by the biasing mechanism 136 to the pressure plate 134.

In various embodiments, by having separate and distinct end plates 122, 132, pressure plates 124, 134, biasing mechanisms 126, 136, and spacing plates 128, 138 for each row of pouch cells 112, 114, greater control over expansion and contraction for each individual row of pouch cells can be provided. In this regard, if the first row of pouch cells 112 expands more than the second row of pouch cells 114 at a given point in time, the biasing mechanism 126 can supply a different pressure to the pressure plate 124 relative to a pressure supplied to the pressure plate 134 by the biasing mechanism 136.

In various embodiments, the biasing mechanisms 126, 136 are gas springs, mechanical springs, coil and leaf springs, combinations of springs and cables, or the like. In various embodiments, the biasing mechanism 126, 136 are gas springs. In this regard, gas springs are compact, have a long life span, and are completely self-contained as to not need anything else to work, in accordance with various embodiments. Additionally, in accordance with various embodiments, gas springs can be a lighter option relative to other biasing mechanisms. Gas springs are light weight very reliable and can have a longer working life relative to coil and leaf springs, in accordance with various embodiments.

In various embodiments, the biasing mechanisms 126, 136 each comprise a cylinder 141 and a piston 142. The piston 142 is coupled to a pressure plate (e.g., pressure plate 124 for biasing mechanism 126 and pressure plate 134 for biasing mechanism 136) at a first end of the piston 142. The piston 142 extends longitudinally (i.e., in the Z-direction) from the first end into the cylinder 141 to a second end of the piston 142. Disposed within the cylinder 141 on a side opposite the piston head of the piston 142, is a compressed gas (e.g., nitrogen), configured to provide a consistent pressure on the piston 142, which in turn provides a consistent pressure to the pressure plate (e.g., pressure plate 124 or pressure plate 134).

In various embodiments, the cylinder 141 of the biasing mechanisms 126, 136 are each fixedly coupled to the support structure 191. Similarly, the end plates 122, 132 of the row of pouch cells 112, 114 are each fixedly coupled to the support structure 192. In various embodiments, the support structure 191 is fixed relative to the support structure 192. In various embodiments, the support structure 191, 192 can form a monolithic component. In this regard, a distance in the longitudinal direction (i.e., the Z-direction) between the support structure 191 and the support structure 192 remains constant (i.e., excluding minor variations due to vibrations or the like) during operation. The support structure 191, 192 can be an airframe, a housing specific to the battery module 100, or the like. The present disclosure is not limited in this regard. Thus, the end plates 122, 132 and the cylinder 141 of the biasing mechanisms 126, 136 are all fixed in six degrees of freedom, and the biasing mechanisms 126, 136 facilitate movement of the row of pouch cells 112, 114 in the longitudinal direction (i.e., the Z-direction defined by a thickness direction of the pouch cells 110).

In various embodiments, the tabs 161, 163 can be a part of a last pouch cell in the row of pouch cells 112, 114, a tab extending from a spacing plate 128, 138, or a tab extending from a pressure plate 124, 134. The present disclosure is not limited in this regard.

In various embodiments, the expanded state of FIG. 2B can also be called a charged state. A “charged state” as referred to herein, is a state where energy is stored in the battery module 100 (e.g., at or near a maximum capacity of the battery module 100). In various embodiments, for certain pouch cell chemistries, such as lithium silicon pouch cells, while the battery module 100 is charging, each pouch cell in the array of pouch cells 110 expands in a thickness direction (i.e., the Z-direction) to a significantly greater degree relative to most commercially available pouch cells, such as lithium-ion pouch cells. In this regard, in response to each pouch cell in the array of pouch cells 110 expanding during charging of the battery module 100, a biasing force on the pressure plates 124, 134 is exceeded by a pressure due to expansion of each pouch cell in the array of pouch cells 110 in the longitudinal direction (i.e., the Z-direction). In response to the biasing force from the biasing mechanisms 126, 136 being exceeded, the piston 142 of each biasing mechanism 126, 136 travels longitudinally into the cylinder 141 until an equilibrium is met, or until the pressure plate 124, 134 contacts the cylinder 141. In various embodiments, the biasing mechanism is configured to reach an equilibrium force after charging. In this regard, a row of pouch cells 112, 114 can have a consistent pressure supplied in the longitudinal direction (i.e., the Z-direction) during charging, after charging, and during operation (i.e., discharging) regardless of a thickness of each pouch cell in the array of pouch cells 110.

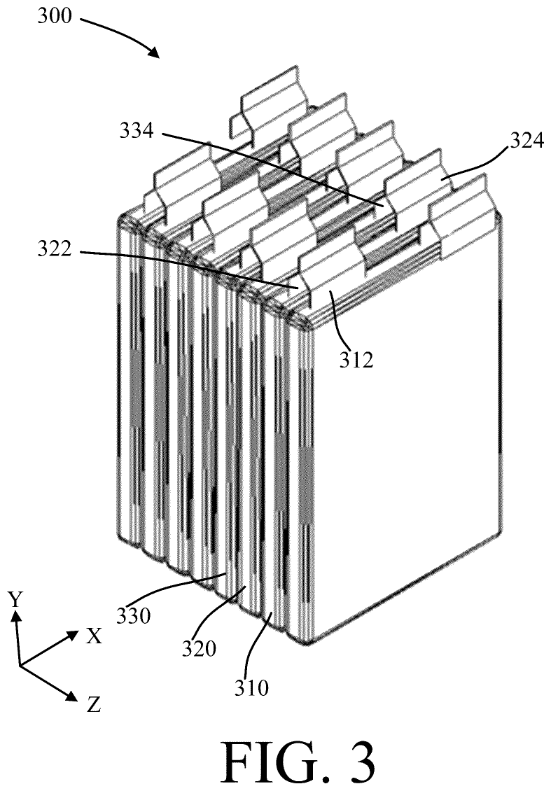

In various embodiments, the electrical coupling between adjacent pouch cells in the array of pouch cells 110 can further facilitate the expansion and compression of the row of pouch cells 112, 114. For example, with reference to FIG. 3, a perspective detail view of a set of pouch cells 300 in an array of pouch cells (e.g., the first row of pouch cells 112 or the second row of pouch cells 114 from FIGS. 1A, 1B, and 2) is illustrated, in accordance with various embodiments. Typical battery modules including pouch cells include rigid bus bars between tabs that are electrically coupled together, or a common bus bar extending along a row of tabs.

In contrast, the set of pouch cells 300 have adjacent tabs coupled together to increase flexibility of the set of pouch cells 300 in the longitudinal direction (i.e., the Z-direction) as described previously herein. The set of pouch cells 300 includes pouch cells 310, 320, 330. The pouch cell 320 is disposed between (i.e., in the Z-direction) a pouch cell 310 and a pouch cell 330. A tab 312 of the pouch cell 310 is coupled to a first tab 322 of the pouch cell 320 on a first lateral side of the pouch cells 310, 320, 330. Similarly, a second tab 324 of the pouch cell 320 is coupled to a tab 334 of the pouch cell 330 on a second lateral side of the pouch cells 310, 320, 330. In various embodiments, each tab (e.g., first tab 322, and second tab 324) can comprise at least two bends. The two bends can facilitate flexibility for the electrical connection, in accordance with various embodiments. In this regard, the electrical connections of a row of pouch cells 112, 114 with the set of pouch cells 300 defines an accordion like shape, in accordance with various embodiments. Thus, expansion and contraction of the set of pouch cells 300 is further facilitated by the configuration of electrical couplings between pouch cells in each set of pouch cells 300 of a row of pouch cells 112, 114 from FIGS. 1A, 1B, and 2.

Although illustrated as having the set of pouch cells 300 coupled together in series, the present disclosure is not limited in this regard. For example, the set of pouch cells 300 could be connected in parallel by aligning the positive tabs of each cell along a longitudinal axis (e.g., the Z-direction), and extending a flexible bus bar along a length of the tabs. In various embodiments, the flexible bus bar could comprise various bends to facilitate expansion and compression of the bus bar during expansion and compression of the battery module 100 as described previously herein.

In various embodiments, the series configuration, as shown in FIG. 3, provides a simpler manufacturing process and maintains the flexibility of the expansion protection system 101 via the accordion shape, in accordance with various embodiments. Moreover, in another example embodiment, a group (e.g. two) of adjacent pouch cells could be configured in parallel by connecting positive tabs on a first lateral side and negative tabs on a second lateral side, and these parallel connected pouch cells could then be connected in series using the same accordion arrangement described above in connection with FIG. 3.

Referring now to FIGS. 4A, 4B, and 4C, a top view of the battery module 100 in a charging (or charged) state 401 (FIG. 4A) and a fully discharged (or discharged) state 402 (FIG. 4B), and a discharging (or discharged) configuration 403 (FIG. 4C) after various cycles of use are illustrated, in accordance with various embodiments. In the charged state 401, an row of pouch cells (e.g., first row of pouch cells 112 and/or second row of pouch cells 114) comprise a longitudinal length L1 (i.e., in the Z-direction) measured from the end plate (e.g., end plate 122 or end plate 132) to the pressure plate (e.g., pressure plate 124 or pressure plate 134). Similarly, in the fully discharged (or default) state 402, the row of pouch cells (e.g., first row of pouch cells 112 and/or second row of pouch cells 114) comprise a second length L2 that is less than the first length L1. In this regard, in response to the pouch cells in the row of pouch cells 112, 114 expanding during charging, a length of the array of pouch cells increases from the longitudinal length L2 in the fully discharged (or default) state 402 to the longitudinal length L1 in the charged state 401. Moreover, in various embodiments, the row of pouch cells 112, 114 may expand during charging from a longitudinal length L2 to a longitudinal length L1 and then return from the longitudinal length L1 to the longitudinal length L2 in response to discharging (or to another length L3 in response to discharging). It should be understood that the cells may not return back to their original size and therefore the array length after discharging may become longer over time (i.e., the longitudinal length L3 is greater than the longitudinal length L2).

In various embodiments, the longitudinal length L1 can be between 5% and 35% greater than the longitudinal length L2, or between 10% and 35% greater than longitudinal length L2, or approximately 25% greater than the longitudinal length L2. In this regard, the expansion protection system 101 can facilitate the use of pouch cell chemistries, such as lithium-silicon pouch cells or the like, that are prone to swelling, or significant volume expansion, during charging without resultant fracturing or crumbling of materials within the pouch cells due to increased stresses. Thus, the expansion protection system 101 can facilitate the use of alternative battery cell chemistries with greater specific capacity compared to typical battery cell chemistries, in accordance with various embodiments.

Referring now to FIGS. 5A and 5B, a perspective view of a battery module 100 with an expansion protection system 101 having a bladder 502 as a biasing mechanism 503 of the biasing system 130 in a fully discharged (or discharged) state 501 (FIG. 5A) and a fully charged (or charged) state 509 (FIG. 5B) are illustrated, with like numerals depicting like elements, in accordance with various embodiments.

Referring now to FIG. 5A, a perspective view of a portion of a battery module 100 with an expansion protection system 101 is illustrated in accordance with various embodiments. In various embodiments, the biasing system 130 of the expansion protection system 101 comprises a bladder 502 in fluid communication with a compressed fluid source 506 (i.e., a pressure vessel) via a fluid conduit 504. In various embodiments, the bladder 502 is passively pressurized by the compressed fluid source 506. In this regard, the bladder 502 can be directly fluidly coupled to the bladder 502 at a pre-set pressure to provide a substantially constant pressure to the set of pouch cells 300 of the battery module 100. “Substantially constant” as referred to herein includes +/−10% from a nominal pressure or +/−5% from a nominal pressure, in accordance with various embodiments.

Although described, as being passively pressurized by the compressed fluid source 506, the present disclosure is not limited in this regard. For example, a valve 508 can be disposed fluidly between the bladder 502 and the compressed fluid source 506. In this regard, the valve 508 can be actively managed to vary a pressure provided to the bladder 502, in accordance with various embodiments.

In various embodiments, the compressed fluid source 506 is external to the battery module 100. Stated another way, the battery module 100 can include a housing 105 that includes the set of pouch cells 300 and the bladder 502 disposed therein, and the compressed fluid source 506 can be disposed external to the housing 105. In various embodiments, the valve 508 can be internal or external to the housing 105. The present disclosure is not limited in this regard.

In various embodiments, the expansion protection system 500 can be utilized with smaller stacks of cells (e.g., between 5 and 15 cells), or approximately 10 cells per stack. In this regard, variations in expansion between stacks of cells (e.g., the set of pouch cells 300) can be more efficiently managed.

Referring now to FIG. 5B, in the fully charged (or charged) state 509, expansion of each cell in the set of pouch cells 300 can compress the bladder 502 until an equilibrium is reached. In this regard, the bladder 502 allows expansion of the cells in the set of pouch cells 300 without damage to the cells and/or a supporting structure, in accordance with various embodiments. In various embodiments, after numerous charge and discharge cycles (i.e., various battery life cycles) of battery module 100 with an expansion protection system 101 having a bladder 502 as the biasing system 130, a length of in the charged state (FIG. 6B) can increase relative to an initial charge state (i.e., after the battery module 100 is manufactured) (e.g., FIG. 6A) for each array of pouch cells (e.g., array of pouch cells 622, 624, 626, 628) in the plurality of battery modules 620. In this regard, after each battery life cycle, the pouch cells in the array of pouch cells 110 can expand further than a prior state. In response to the expansion, the biasing system 130 can maintain a consistent pressure on each array of pouch cells (e.g., array of pouch cells 622, 624, 626, 628) as described previously herein. Accordingly, the expansion protection system 601 of the battery system 605 can extend a life of the array of the cells in the battery system 600, by preventing damage to cells in the array of pouch cells in response to the expansion of the pouch cells, in accordance with various embodiments.

Referring now to FIGS. 6A and 6B, a top-down cross-sectional view of a battery system 600 with the expansion protection system 101 having a plurality of the biasing system 130 is illustrated in accordance with various embodiments. Although illustrated as including a plurality of the bladder 502 as the biasing system 130, the present disclosure is not limited in this regard. For example, the battery system 600 can include a plurality of the springs as the biasing system 130, in accordance with various embodiments, and as described previously herein.

In various embodiments, the battery system 600 comprises a housing 610 and a plurality of battery modules 620 (e.g., a plurality of sets of pouch cells 300, also referred to herein as array of pouch cells 622, 624, 626, 628). The housing 610 defines a plurality of cavities (e.g., first cavity 611, second cavity 612, third cavity 613, fourth cavity 614, etc.). Although illustrated with four cavities in the plurality of cavities, the housing 610 is not limited in this regard. For example, any number of cavities of two or more for the battery system 600 is within the scope of this disclosure.

In various embodiments, each cavity is defined laterally between a first sidewall 691 and a second sidewall 692. The first sidewall 691 and the second sidewall 692 each extend longitudinally (i.e., in a Z-direction) from a first longitudinal end of the housing 610 to a second longitudinal end of the housing 610. Similarly, each cavity is defined longitudinally between a first support structure and a second support structure (e.g., between support structures 615, 616 for the first cavity 611, between support structures 616, 617 for the second cavity 612, between support structures 617, 618 for the third cavity 613, and between support structures 618, 619 for the fourth cavity 614). Accordingly, the support structures 615, 616, 617, 618, 619 each extend laterally from the first sidewall 691 to the second sidewall 692. In various embodiments, the housing 610 includes an outer perimeter defined by the sidewalls 691, 692, and support structure 615 disposed at a first longitudinal end of the housing 610 and support structure 619 disposed at a second longitudinal end opposite from the first longitudinal end.

In various embodiments, each battery module in the plurality of battery modules 620 comprises a biasing system as described previously herein. For example, a first biasing system 632 can be disposed in the first cavity 611, a second biasing system 634 can be disposed in the second cavity 612, and so on. In this regard, each biasing system 130 has a corresponding cavity in the plurality of cavities. Accordingly, each array of pouch cells can have a biasing system adaptable to the respective array of pouch cells. In various embodiments, by separating a battery system 600 into various battery modules 620 (e.g., array of pouch cells 622, 624, 626, 628) with independent biasing systems (e.g., biasing systems 632, 634, 636, 638), a life of the battery system 600 can be improved relative to a battery system without the biasing systems, or a battery system with a single biasing system and the same number of cells.

The biasing system 130 is configured to abut a respective support structure defined by the housing 610 (e.g., biasing system 632 abuts supports the structure 615, biasing system 634 abuts the support structure 616, biasing system 636 abuts the support structure 617, biasing system 638 abuts the support structure 618). For example, the first biasing system 632 is configured as an expansion protection sub-system for the array of pouch cells 622, the second biasing system 634 is configured as an expansion protection sub-system for the array of pouch cells 624, and so on. In this regard, the first biasing system 632 is disposed in the first cavity 611 and configured to abut a support structure 615 (e.g., a first support structure) and a first longitudinal end of the array of pouch cells 622. Similarly, the second biasing system 634 is disposed in the second cavity 612 and configured to abut a support structure 616 (e.g., a second support structure) and a first longitudinal end of the array of pouch cells 624. In various embodiments, the support structure 616 for the second biasing system 634 abuts a second longitudinal end (e.g., a fixed end) of the first array of pouch cells 622. In this regard, the first array of pouch cells 622 are configured to expand and compress in a longitudinal direction towards and away from the support structure 615. Similarly, the second array of pouch cells is disposed longitudinally between the second biasing system 634 and the support structure 617. In this regard, the second array of pouch cells 624 includes a fixed longitudinal end at the support structure 617 and is configured to translate relative to the support structure 616.

In various embodiments, each array of pouch cells (e.g., array of pouch cells 622, 624, 626, 628) can be electrically coupled together to form the battery system 600. For example, the array of pouch cells can be electrically coupled through the housing 610 (i.e., to ensure that each array of pouch cells is electrically coupled at a respective fixed end).

In various embodiments, each biasing system (e.g., biasing system 632, 634, 636, 638) includes a bladder (e.g., bladders 642, 644, 646, 648). In various embodiments, each bladder (e.g., bladders 642, 644, 646, 648) is configured to be fluidly coupled to a compressed fluid source 506. In various embodiments, a valve 508 can be disposed between the bladders 642, 644, 646, 648 and the compressed fluid source 506. However, the present disclosure is not limited in this regard. For example, the battery system 600 can be without the valve 508 and still be within this disclosure. In this regard, the battery system 600 could supply a constant pressure to the bladders 642, 644, 646, 648, in accordance with various embodiments. In various embodiments, the valve 508 can be controlled through a controller (e.g., a processor and a non-transitory memory, or the like). Accordingly, a pressure supplied to the bladders 642, 644, 646, 648 can be varied and still be within the scope of this disclosure.

In various embodiments, the array of pouch cells 622, 624, 626, 628 each include two rows of pouch cells. In this regard, a high side (e.g., a positive side) of each array of pouch cells can be on a fixed side (e.g., on support structure 616 side for array of pouch cells 622, on support structure 617 side for array of pouch cells 624, on support structure 618 side for array of pouch cells 626, and on support structure 619 side for array of pouch cells 628). Similarly, the low side of each array of pouch cells can be disposed on the fixed side laterally adjacent to the first high side. Accordingly, the array of pouch cells can be electrically coupled in series from the fixed side to the moveable side (e.g., adjacent to the biasing system 130) and back to the fixed side as shown, in accordance with various embodiments.

In various embodiments, after numerous charge and discharge cycles (i.e., various battery life cycles) of the battery system 600, a length in the charged state (FIG. 6B) can increase relative to a length in an initial charge state (i.e., after the battery modules 600 are manufactured) (e.g., FIG. 6A) for each array of pouch cells (e.g., array of pouch cells 622, 624, 626, 628). In this regard, after each battery life cycle, the pouch cells in the array of pouch cells 622, 624, 626, 628 can expand further than a prior state. In response to the expansion, the biasing system 130 for each array of pouch cells (e.g., array of pouch cells 622, 624, 626, 628) can maintain a substantially constant pressure on each array of pouch cells (e.g., array of pouch cells 622, 624, 626, 628) as described previously herein. Accordingly, the expansion protection system 601 of the battery system 605 can extend a life of the array of the cells in the battery system 600, by preventing damage to cells in the array of pouch cells in response to the expansion of the pouch cells, in accordance with various embodiments.

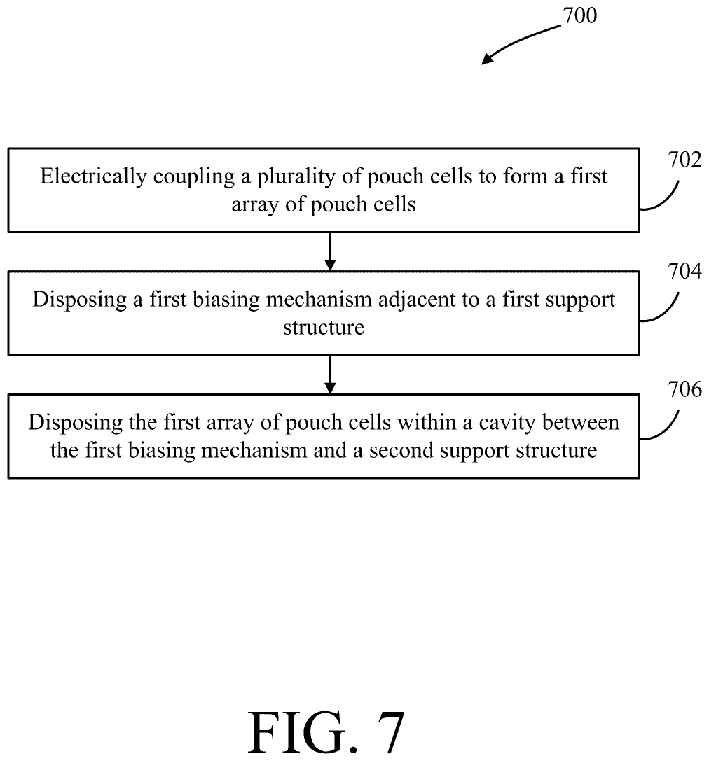

Referring now to FIG. 7, a method 700 of assembling a battery module with an expansion protection system is illustrated, in accordance with various embodiments. The method 700 comprises electrically coupling a plurality of pouch cells to form an array of pouch cells (step 702). In various embodiments, the plurality of pouch cells are coupled together in accordance with the set of pouch cells 300 from FIG. 3. In this regard, the plurality of pouch cells can be disposed adjacent to at least one pouch cell and have at least one tab coupled to an adjacent tab of an adjacent pouch cell. In various embodiments, each tab can have at least two bends to provide flexibility to the electrical interface during expansion and compression. In various embodiments, the array of pouch cells includes a first row and a second row (e.g., as shown in FIGS. 1, 2A-B, 5A-B, and 6).

In various embodiments, the method 700 further comprises disposing a biasing mechanism (e.g., biasing mechanisms 126, 136 biasing mechanism 502, or the like) adjacent to the first support structure (step 704). In various embodiments, the first support structure is spaced apart longitudinally from a second support structure (e.g., support structures 615 being spaced apart longitudinally from support structure 616, support structure 191 being spaced apart from support structure 192, or the like).

In various embodiments, the method 700 further comprises disposing the array of pouch cells within a cavity between the biasing mechanism and a second support structure (e.g., between biasing mechanism 126 and support structure 192 as shown in FIGS. 2A, 2B, between biasing mechanism 503 and bladder 642 and support structure 616 as shown in FIGS. 6A, 6B, or the like) (step 706).

In various embodiments, the method 700 can further comprise disposing a second biasing mechanism adjacent to the first support structure (e.g., biasing mechanism 136 being disposed adjacent to support structure 191 in FIGS. 2A, 2B). In various embodiments, the biasing mechanism can be configured to abut a first pouch cell in the first row of pouch cells (e.g., row of pouch cells 112 from FIG. 2A, 2B), and the second biasing mechanism is configured to abut a second pouch cell in the second row of pouch cells (e.g., row of pouch cells 114 from FIGS. 2A, 2B). In this regard, the first biasing mechanism and the second biasing mechanism can be disposed laterally adjacent to each other on a first longitudinal end of the battery system as shown in FIGS. 2A, 2B.

In various embodiments, the biasing mechanism of method 700 can be a bladder (e.g., bladder 502 from FIG. 5, bladder 642, 644, 646, 648 from FIG. 6A, 6B, or the like). In various embodiments, the method 700 can further comprise fluidly coupling a compressed fluid source (e.g., compressed fluid source 506 from FIGS. 6A, 6B) to the bladder. The bladder can then be configured to supply a substantially constant pressure to at least one of the first row of pouch cells and the second row of pouch cells.

While the principles of this disclosure have been shown in various embodiments, many modifications of structure, arrangements, proportions, elements, materials and components (which are particularly adapted for a specific environment and operating requirements) may be used without departing from the principles and scope of this disclosure. These and other changes or modifications are intended to be included within the scope of the present disclosure and may be expressed in the following claims.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments.

However, benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

When language similar to “at least one of A, B, or C” or “at least one of A, B, and C” is used in the claims or specification, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

Example 1: A battery system, comprising: a housing defining a first cavity and a second cavity; a first biasing system disposed in the first cavity and configured to abut a first support structure; a second biasing system disposed in the second cavity and configured to abut a second support structure; a first array of pouch cells disposed longitudinally between the first biasing system and the second support structure; and a second array of pouch cells disposed longitudinally between the second biasing system and a third support structure.

Example 2: The battery system of example 1, wherein the first biasing system and the second biasing system each comprise a bladder.

Example 3: The battery system of example 2, further comprising a compressed fluid source in fluid communication with the bladder of the first biasing system and the bladder of the second biasing system.

Example 4: The battery system of example 1, wherein the first array of pouch cells is electrically coupled to the second array of pouch cells.

Example 5: The battery system of example 1, wherein the first array of pouch cells and the second array of pouch cells each comprise a first row of pouch cells and a second row of pouch cells.

We claim:

1. A battery module, comprising:
a first support structure;
a second support structure spaced apart from the first support structure in a longitudinal direction;
an array of pouch cells disposed between the first support structure and the second support structure; and
an expansion protection system including a biasing system, the biasing system disposed between the second support structure and the array of pouch cells, the biasing system spaced apart from the first support structure by a distance, the expansion protection system configured to allow the distance to increase from a first length to a second length in response to transitioning the array of pouch cells from a discharged state to a charged state.

2. The battery module of claim 1, wherein a first pouch cell in the array of pouch cells abuts a second pouch cell on a first side and a third pouch cell on a second side.

3. The battery module of claim 2, wherein:
each pouch cell in the array of pouch cells comprises a positive tab spaced apart laterally from a negative tab,
the positive tab of the first pouch cell is physically and electrically coupled to the negative tab of the second pouch cell on a first lateral side of the first pouch cell, and
the negative tab of the first pouch cell is physically and electrically coupled to the positive tab of the third pouch cell on a second lateral side of the first pouch cell.

4. The battery module of claim 3, wherein the negative tab and the positive tab comprise at least two bends.

5. The battery module of claim 1, wherein the second length is between 10% and 35% greater than the first length.

6. The battery module of claim 1, wherein the biasing system comprises one of a bladder and a spring.

7. The battery module of claim 1, wherein the array of pouch cells includes a first row of pouch cells and a second row of pouch cells, the first row of pouch cells spaced apart laterally from the second row of pouch cells.

8. The battery module of claim 7, wherein:
the array of pouch cells define an electrical path from a positive terminal to a negative terminal,
the positive terminal is disposed distal to the biasing system in the longitudinal direction, and
the negative terminal is disposed distal to the biasing system in the longitudinal direction.

9. The battery module of claim 8, wherein:
a first pouch cell in the first row of pouch cells defines the positive terminal,
a second pouch cell in the second row of pouch cells defines the negative terminal, and
the first pouch cell is disposed laterally adjacent to the second pouch cell.

10. The battery module of claim 1, wherein each pouch cell in the array of pouch cells is one of a lithium-silicon based cell or a lithium-metal based cell.

11. An expansion protection system, comprising:
a first support structure;
a second support structure spaced apart from the first support structure; and
a biasing mechanism configured to abut the second support structure, the biasing mechanism and the first support structure configured to receive an array of pouch cells there between, the biasing mechanism configured to supply passive pressure to the array of pouch cells during operation, the expansion protection system configured to allow a first distance of the array of pouch cells to increase from a first length to a second length in response to the array of pouch cells transitioning from a discharged state to a charged state.

12. The expansion protection system of claim 11, wherein the second length is between 10% and 35% greater than the first length.

13. The expansion protection system of claim 11, wherein the biasing mechanism comprises one of a bladder and a spring.

14. The expansion protection system of claim 11, further comprising a compressed fluid source, wherein the biasing mechanism comprises a bladder, and wherein the bladder is in fluid communication with the compressed fluid source.

15. The expansion protection system of claim 14, wherein the compressed fluid source is configured to supply a substantially constant pressure to the bladder.

16. The expansion protection system of claim 11, further comprising a first pressure plate spaced apart from the second support structure, wherein the biasing mechanism is coupled to the first pressure plate.

17. The expansion protection system of claim 16, further comprising:
a second pressure plate configured to be spaced apart from the second support structure; and
a second biasing mechanism coupled to the second pressure plate and disposed between the second support structure and the second pressure plate, the second biasing mechanism configured to supply passive pressure to the second pressure plate during operation.

18. A method of assembling a battery module, the method comprising:
electrically coupling a plurality of pouch cells to form an array of pouch cells, the array of pouch cells including a first row of pouch cells and a second row of pouch cells;
disposing a biasing mechanism adjacent to a first support structure of a housing, the first support structure spaced apart from a second support structure of the housing; and
disposing the array of pouch cells within a cavity defined between the first support structure and the second support structure, the array of pouch cells configured to abut the biasing mechanism.

19. The method of claim 18, further comprising disposing a second biasing mechanism adjacent to the first support structure, wherein:
the biasing mechanism is configured to abut a first pouch cell in the first row of pouch cells from the array of pouch cells, and
the second biasing mechanism is configured to abut a second pouch cell in the second row of pouch cells from the array of pouch cells.

20. The method of claim 18, wherein the biasing mechanism comprises a bladder, and wherein the method further comprises fluidly coupling a compressed fluid source to the bladder, the bladder configured to supply a substantially constant pressure to at least one of the first row of pouch cells and the second row of pouch cells from the array of pouch cells.
